(19) United States
(12) Patent Application Publication
(10) Pub. No.: US 2015/0343839 A1
(43) Pub. Date: Dec. 3, 2015

(54) DECORATIVE, PRECAST, CEMENTITIOUS STRUCTURE HAVING A MICRO-TEXTURED, LASER-ENGRAVED, FRONT SURFACE

(71) Applicant: Dennis M. Hill, St. Clair, MI (US)

(72) Inventor: Dennis M. Hill, St. Clair, MI (US)

(21) Appl. No.: 14/722,287

(22) Filed: May 27, 2015

Related U.S. Application Data
(60) Provisional application No. 62/005,005, filed on May 30, 2014.

(51) Int. Cl. B44F 11/02; B44C 1/22

(52) U.S. Cl. CPC B44F 11/02; B44C 1/225; B44C 1/228

(57) ABSTRACT

A decorative, precast, cementitious structure is provided. The structure comprises a cementitious composition comprised of a cement and an aggregate substantially homogeneously distributed through the composition. The structure has a relatively smooth front surface with a micro-textured region engraved by a laser beam having energy which is absorbed by a void-free front surface layer of the structure to at least initiate ablation of the material of the surface layer at a pattern of predetermined locations on the front surface to form the micro-textured region.

### CROSS REFERENCE TO RELATED APPLICATION

This application claims the benefit of U.S. provisional application serial No. 62/005,005 filed May 30, 2014.

### TECHNICAL FIELD

This invention relates to decorative, precast, cementitious structures and, in particular, to decorative, precast, cementitious structures having front surfaces which have a micro-textured, laser-engraved region or regions.

### Overview

U.S. Pat. No. 8,393,685 discloses an interlocking precast slab assembly such as a bench or memorial marker. Each assembly includes a precast seat member and a precast non-shrink grout back member having a front surface engraved with a design such as a photo-realistic image. The precast grout back member has a plurality of closely spaced, vertically extending, V-shaped grooves formed from a photo-engraved formliner. One problem associated with such engraved surfaces is that the image is not viewable at certain angles.

U.S. Pat. No. 6,064,034 discloses a laser marking system for vitrification of a brick, tile, paver, or pot. A laser such as a continuous wave Nd:Yag or carbon dioxide unit is configured for vitrescence of an object placed in the path of the beam. The beam is steered via computer controlled motors attached to reflecting mirrors located in the path of the beam. Graphical characters and letters can be vitrified into the surface of objects which are placed in the working area of the beam by running computer software for controlling the beam steering mirrors. A laser with adequate vitrification power will then vitrify, or change to glass, the surface of clay-containing objects falling in the path of the laser beam. The width of the beam, temperature and moisture content of the clay-containing object, gaseous atmosphere at the work surface and speed of beam movement can be optimized to maximize the through-put of a laser marking system. The laser marking system might also be mounted on a mobile unit for vitrification of already mounted bricks, pavers, or other such objects.

U.S. Pat. No. 6,822,192 discloses a brick, and similar article, engraving process utilizing a CO₂ continuous beam laser guided over a beam path which outlines a graphic image on the article being engraved and repeats the beam path at incrementally spaced positions of the beam until the width of the graphic image is defined, thereby concentrating the heat of the laser engraving process in the vicinity of the graphic image during the process. The graphic image may be engraved in one or two passes of the beam over the surface of the article being engraved, such as common construction brick, wherein the engraving has minimal reflectivity and is of a uniform dark color providing an enhanced engraved article.

U.S. Pat. No. 7,126,082 discloses a large format, plotter-style automated laser engraver which can be used to engrave various materials. A cabinet body supports a substantially flat work surface which can be raised or lowered as desired. A gantry assembly is mounted in close proximity to such work surface, and facilitates movement of a focused laser assembly to any xly coordinate along the work surface. A computer controlled wireless focus mechanism is used to regulate the vertical distance between the focused laser assembly and the work surface. Air is provided to cool the work surface during the engraving process.

U.S. Pat. No. 8,232,502 discloses a method for engraving an image on a surface of an article selected from a group consisting of brick, ceramic tile, concrete pavers and natural stone articles, comprising providing a laser engraving apparatus comprising a steerable laser beam, steering the laser beam continuously over a first beam path on the surface to provide an engraved image and repeatedly traversing the laser beam over a path substantially parallel to the first beam path and incrementally spaced therefrom to define a perimeter of the engraved image. The method further comprises steering the laser beam within an infill area defined by the perimeter of the engraved image to provide a plurality of engraved segments extending within infill area.

U.S. Patent Publication 2004/0137201 discloses a method for providing a multi-colored, long-lasting engraved mark on the surface of a brick or other similar ceramic object. Masks are used to separate coloring agents during the engraving process such that variegated designs may be created. A groove may be placed in the surface of the brick over the area to be engraved to provide a substratum for the coloring agent. The coloring agent is placed in the groove and subjected to heating such that it melts and fuses with the underlying brick surface within the groove. The coloring agent is comprised of colored glass frit particles. A laser is optimally used for providing both the grooving and the heating steps.

U.S. Patent Publication 2012/0021194 discloses methods for marking a substrate, in particular, methods for applying visual indicia to a substantially cementitious substrate in the form of a cementitious building product. The method comprising the steps of: irradiating a surface of said substantially cementitious substrate for a sufficient time and with sufficient energy to at least partially vitrify said surface thereby marking said substrate.

Other U.S. patent documents related to at least one embodiment of the present invention include U.S. Pat. Nos. 4,955,305; 4,970,600; 4,985,780; 6,984,803; 7,570,683; 7,726,220; 7,894,500; and U.S. Patent Publication 2009/0212029.

Epilog Laser of Golden, Colorado makes a wide variety of laser cutting and engraving systems, some of which are capable of photo engraving workpieces from digital photographs.

As described in U.S. Pat. No. 5,547,504, and as used herein, grout is generally a mixture of sand and Portland cement which meets certain specifications, although for limited applications it can be prepared without sand as a filler. Non-shrink grouts are dimensionally stable and are used in applications such as: (1) precision grouting of machinery bases; (2) structural grouting of precast columns, steel columns, crane rails, precast beams, and the like; and (3) enclosing guard rails, sign posts, bridge seats, anchor bolts, guide rails, dowels, etc. Dimensional stability over time is a key requirement for non-shrink grout (ASTM C 1107 & CRD-C6 21) (ASTM C1107-91a, “Standard Specifications for Packaged Dry, Hydraulic Cement Grout (Non-Shrink),” (1991); and CRD-C 621-82B, “Corps of Engineers Specifications for Non-shrinkage Grout,” (1982)).

U.S. Pat. No. 5,547,504 discloses a non-shrink grout including Portland cement, sand and an additive which is a polymer incorporating at least one of a calcium compound and aluminum metal so as to be reactive with the cement. The grout when fresh expands during curing by gas formation and by hydration and expands when hardened.

U.S. Pat. No. 7,910,162 discloses a dry, non-shrink composition which is admixed with water to cure into a hard but flexible and non-shrinking grout for laying paver stones, the dry composition comprising ingredients by percent weight of: 94-96% silica sand; 2-4% polymer powder mixture of vinyl acetate, and a vinyl ester in equal proportions, jointly polymerized using ethane; 0.5-1.5% cement; and 0.5-1.5% colorant. The dry composition is swept into joints between paver stones and water is then added to hydrate the dry mixture which forms a grouting material with interlocking physical joints to a porous material such as travertine.

Despite the above, there is a need for a laser-cut, high strength, precast, cementitious structure which is laser-engraved to form a decorative structure whose front surface has a micro-textured region which can form a high resolution image, design, etc.

### SUMMARY OF EXAMPLE EMBODIMENTS

An object of at least one embodiment of the present invention is to provide a low cost, high strength, precast, cementitious structure which is laser engraved to form a decorative structure whose front surface has a micro-textured region which can form a high resolution image, design, etc.

In carrying out the above object and other objects of at least one embodiment of the present invention, a decorative, precast, cementitious structure is provided. The structure comprises a cementitious composition comprised of a cement and an aggregate substantially homogeneously distributed through the composition. The structure has a relatively smooth front surface with a micro-textured region engraved by a laser beam having energy which is absorbed by a void-free front surface layer of the structure to at least initiate ablation of the material of the surface layer at a pattern of predetermined locations on the front surface to form the micro-textured region.

The structure may be a non-shrink grout structure wherein the aggregate is a fine aggregate.

The structure may be a compressive strength of at least 6,000 PSI.

The micro-textured region may form an image having a resolution defined by the number of possible marking dots per square inch (DPI) in the surface layer of the structure. The resolution may be greater than or equal to about 1200 DPI.

The composition may further include at least one of pigments and a coloring agent substantially homogeneously distributed through the composition.

The micro-textured region may form a photorealistic image and/or a design.

The grout may meet standards established by ASTM C-1107 and CRD-621.

The cement may be a hydraulic cement and the aggregate may be a fine aggregate.

Other technical advantages will be readily apparent to one skilled in the art from the following figures, descriptions and claims. Moreover, while specific advantages have been enumerated, various embodiments may include all, some or none of the enumerated advantages.

### BRIEF DESCRIPTION OF THE DRAWINGS

FIG. 1 is a digital photograph of a dog, together with a memorial indicia;

FIG. 2 is a front elevational view of a decorative, precast cementitious structure which has been laser-engraved to form a micro-textured region which, in turn, forms a photorealistic image which corresponds to the digital photograph of FIG. 1;

FIG. 3 is an angled view of the structure of FIG. 1 to show that the image is viewable at an angle;

FIG. 4 is a back angled view of the structure; and

FIG. 5 is an enlarged view of the micro-textured region of the front surface of the structure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The terms “aggregate” and “aggregate fraction” refer to the fraction of concrete which is generally non-hydraulically reactive. The aggregate fraction is typically comprised of two or more differently-sized particles, often classified as fine aggregates and coarse aggregates.

As used herein, the terms “coarse aggregate” and “coarse aggregates” refer to solid particulate materials that are retained on a Number 4 sieve (ASTM C125 and ASTM C33). Examples of commonly used coarse aggregates include ⅜ inch rock and ¾ inch rock.

The terms “hydraulically settable composition” and “cementitious composition” are meant to refer to a broad category of compositions and materials that contain both a hydraulically settable binder and water as well as other components, such as aggregates and fibers, regardless of the extent of hydration or curing that has taken place. As such, the cementitious materials include hydraulic pastes or hydraulically settable compositions in a green state (i.e., unhardened, soft, or moldable), and a hardened or cured cementitious composite product.

The term “homogeneous” is meant to refer to a composition to be evenly mixed so that at least two random samples of the composition have roughly or substantially the same amount, concentration, and distribution of a component.

The terms “hydraulic cement,” “hydraulically settable binder,” “hydraulic binder,” or “cement” are meant to refer to the component or combination of components within a cementitious or hydraulically settable composition that is an inorganic binder such as, for example, Portland cements, fly ash, and gypsums that harden and cure after being exposed to water. These hydraulic cements develop increased mechanical properties such as hardness, compressive strength, tensile strength, flexural strength, and component surface bonds (e.g. binding of aggregate to cement) by chemically reacting with water.

The terms “hydraulic paste” or “cement paste” are meant to refer to a mixture of hydraulic cement and water in the green state as well as hardened paste that results from hydration of the hydraulic binder. As such, within a hydraulically settable composition, the cement paste binds together the individual solid materials, such as fibers, cement particles, aggregates, and the like.

The term “composite” is meant to refer to a form-stable composition that is made up of distinct components such as fibers, rheology-modifiers, cement, aggregates, set accelerators, and the like.

The term “stone-like” or “stone-like properties” is meant to refer to cementitious compositions and extruded cementitious composite building properties having a hardness value of at least 4 MOH, more suitably, at least about 5 MOH, even more suitably a hardness of at least about 6 MOH, and even more suitably a hardness of 7 to 8 MOH.

Natural and synthetic admixtures are used to color cementitious composition for aesthetic and safety reasons. Coloring admixtures are usually composed of pigments and include carbon black, iron oxide, phthalocyanine, umber, chromium oxide, titanium oxide and cobalt blue.

In a preferred embodiment, an integral concrete dye or colorant is added and is available from Butterfield Color Inc. of Aurora, Illinois.

In a preferred embodiment, the cementitious composition comprises a non-shrink, precision grout available from Quikcrete® of Atlanta, Georgia. QUIKRETE® Non-Shrink Precision Grout is high strength, non-metallic, Portland cement based material with expansive additives designed for grouting all types of machinery, steel columns, bearing plates, pre-cast concrete, and anchoring applications and has the following properties:

### Physical/Chemical Properties

QUIKRETE® Non-Shrink Precision Grout complies with all properties of ASTM C1107 and CRD 621 producing the results shown in Table 1.

TABLE 1
TYPICAL PHYSICAL PROPERTIES AT 73° F. (23° C.)
Compressive strength, ASTM C109 modified per ASTM C1107

| Plastic consistency | | |
|---|---|---|
| 1 day | 3000 | psa (20.7 MPa) |
| 3 days | 9500 | psi (65.5 MPa) |
| 7 days | 10,000 | psi (68.9 MPa) |
| 28 days | 14,000 | psi (96.5 MPa) |
| Height change, ASTM C1090 | | |
| 1, 3, 7 and 28 days | 0-0.2% | |
| Height change, ASTM C827 | +0.6% | |
| Flowable consistency | | |
| 1 day | 3000 | psi (20.7 MPa) |
| 3 days | 9000 | psi (62.1 MPa) |
| 7 days | 9500 | psi (65.5 MPa) |
| 28 days | 12,500 | psi (86.2 MPa) |
| Height change, ASTM C1090 | | |
| 1, 3, 7 and 28 days | 0-0.2% | |
| Height change, ASTM C827 | +0.4% | |
| Fluid consistency | | |
| 1 day | 2500 | psi (17.2 MPa) |
| 3 days | 5000 | psi (34.5 MPa) |
| 7 days | 6000 | psi (41.4 MPa) |
| 28 days | 8000 | psi (56.2 MPa) |
| Height change, ASTM C1090 | | |
| 1, 3, 7 and 28 days | 0-0.2% | |
| Height change, ASTM C827 | +0.3% | |
| Pull-out strength, ASTM E488 | 35,000 | psi (241 MPa) |

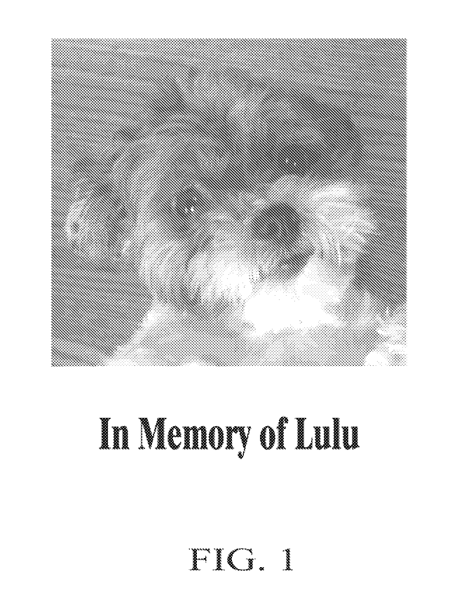

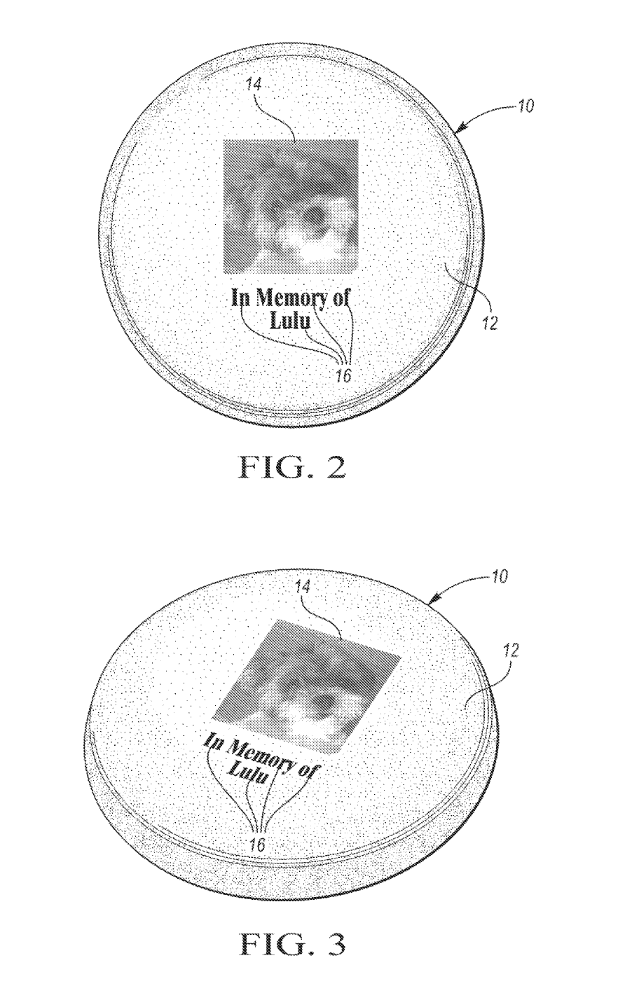

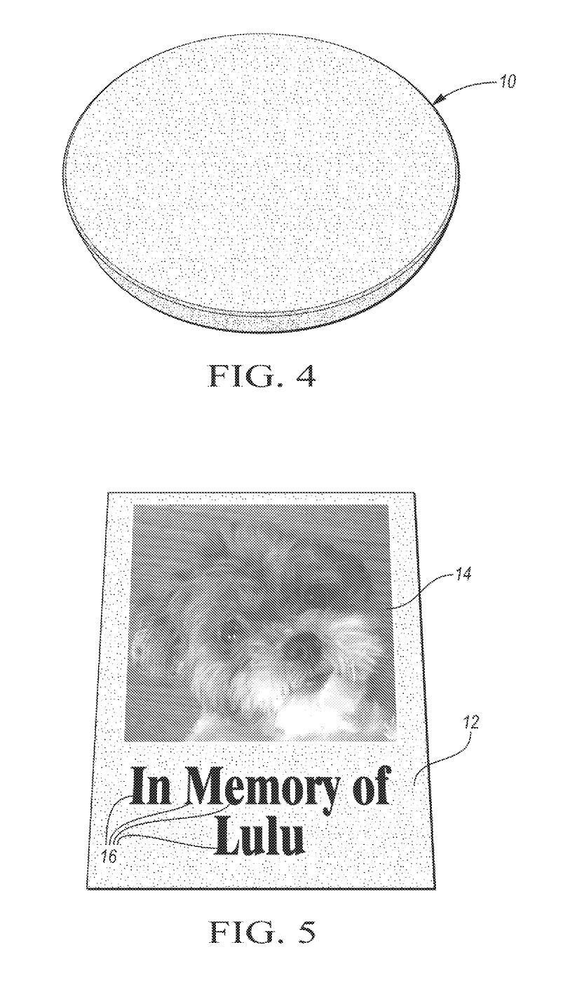

In general, as shown in FIGS. 2, 3, and 5, a decorative, precast, cementitious structure is generally indicated at 10. The structure 10 includes a cementitious composition comprised of a cement and an aggregate substantially homogenously distributed through the composition. The structure has a relatively smooth front surface 12 with a micro-textured region 14 engraved by a laser beam having energy which is absorbed by a void-free front surface layer of the structure 10 to at least initiate ablation of the material of the surface layer at a pattern of predetermined locations on the front surface to form the micro-textured region 14. In a preferred embodiment, a laser cutting and engraving system to perform the engraving form a digital image such as the digital image of FIG. 1, is available from Epilog Laser Inc. of Golden, Colo. The structure 10 is preferably a non-shrink grout structure wherein the aggregate is a fine aggregate such as sand.

The structure 10 may have a compressive strength of at last 6,000 psi and preferably about 8,000 psi.

The micro-textured region 14 forms an image having a resolution defined by the number of possible marking dots per square inch (DPI) in the surface layer of the structure 10. The resolution is greater than or equal to about 1200 DPI as shown in FIGS. 2, 3 and 5.

The composition further comprises at least one of pigments and a coloring agent substantially homogeneously distributed through the composition.

The micro-textured region may form a photorealistic image such as the image of the dog named “Lulu.”

The micro-textured region may also form a design such as the indicia 16 which forms a memorial inscription.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A decorative, precast, cementitious structure comprising a cementitious composition comprised of a cement and an aggregate substantially homogeneously distributed through the composition and having a relatively smooth front surface with a micro-textured region engraved by a laser beam having energy which is absorbed by a void-free front surface layer of the structure to at least initiate ablation of the material of the surface layer at a pattern of predetermined locations on the front surface to form the micro-textured region.

2. The structure as claimed in claim 1, wherein the structure is a non-shrink grout structure and wherein the aggregate is a fine aggregate.

3. The structure as claimed in claim 1, wherein the structure has a compressive strength of at least 6,000 PSI.

4. The structure as claimed in claim 1, wherein the micro-textured region forms an image having a resolution defined by the number of possible marking dots per square inch (DPI) in the surface layer of the structure.

5. The structure as claimed in claim 4, wherein the resolution is greater than or equal to about 1200 DPI.

6. The structure as claimed in claim 1, wherein the composition further comprises at least one of pigments and a coloring agent substantially homogeneously distributed through the composition.

7. The structure as claimed in claim 4, wherein the micro-textured region forms a photorealistic image.

8. The structure as claimed in claim 7, wherein the micro-textured region forms a design.

9. The structure as claimed in claim 2, wherein the grout meets standards established by ASTM C-1107 and CRD-621.

10. The structure as claimed in claim 1, wherein the cement is a hydraulic cement and the aggregate is a fine aggregate.
